(19) United States
(12) Patent Application Publication
(10) Pub. No.: US 2025/0162352 A1
(43) Pub. Date: May 22, 2025

(54) Tire Tread for a Heavy Civil-Engineering Vehicle with Improved Trade-off Between Strength/Thermal Wear

(71) Applicant: COMPAGNIE GENERALE DES ETABLISSEMENTS MICHELIN, CLERMONT-FERRAND (FR)

(72) Inventors: Olivier SPINNLER, CLERMONT-FERRAND Cedex 9 (FR); Adrien TRAVERSE, CLERMONT-FERRAND Cedex 9 (FR); Alvaro VILLA-RECIO, CLERMONT-FERRAND Cedex 9 (FR)

(21) Appl. No.: 18/573,703

(22) PCT Filed: Jun. 13, 2022
(86) PCT No.: PCT/FR2022/051123

§ 371 Date: Aug. 15, 2024

(30) Foreign Application Priority Data
Jun. 24, 2021 (FR) FR2106742

(51) Int. Cl. B60C 11/03

(52) U.S. Cl. CPC B60C 11/0309; B60C 11/0304; B60C 2011/0353; B60C 2011/0355; B60C 2200/065

(57) ABSTRACT

A tire tread 1 for a heavy civil-engineering vehicle to provide trade-off between resistance to mechanical attacks and thermal venting. The tread has a medial portion 11 with at least one longitudinal row of blocks 3, each being delimited transversely by two longitudinal channels 41 having a radially outer portion 411 and a radially inner portion 412, and longitudinally by two inter-block transverse cut-outs 42, having a radially outer portion 421 and a radially inner portion 422. The maximum thickness (E11max, E21max) of each outer portion (411, 421) is, at most, equal to 20% of the depth (P1, P2) of the cut-out (41, 42) and strictly less than the maximum thickness (E12max, E22max) of the inner portion (412, 422), and the minimum thickness (E11min, E21min) of each outer portion (411, 421) is at least equal to 5% of the depth (P1, P2) of the cut-out (41, 42).

The present invention relates to a tire tread for a heavy vehicle, designed to carry heavy loads and to run on irregular, stony and/or muddy ground, for example a civil engineering vehicle of the dumper type for use in mines or quarries.

A tread comprises at least one rubber-based material and is designed to form the peripheral part of a tire and to become worn when its running surface comes into contact with the ground.

A tread may be defined geometrically by three dimensions, namely a smallest dimension or thickness, in a direction perpendicular to the running surface, an intermediate direction or width, in a transverse direction, and a largest dimension or length, in a longitudinal direction. If the tread is integrated into the tire, the direction perpendicular to the running surface is also called the radial direction, because it is defined along a radius of the tire; the transverse direction is also called the axial direction, because it is parallel to the axis of rotation of the tire; and the longitudinal direction is also called the circumferential direction, because it is tangential to the circumference of the tire in the running direction of the tire. In the following text, “radially” signifies “in a direction perpendicular to the running surface” or “in a radial direction”.

To ensure satisfactory performance in longitudinal grip, under engine torque and braking torque, and in transverse grip, a combination of cut-outs separating relief elements, called the sculpture, must be formed in the tread.

A cut-out is geometrically characterized by its thickness, which is the distance between the walls of material delimiting it, and by its depth, which is the distance between the running surface and the bottom of said cut-out, that is to say its radially innermost point. The thickness may vary according to the radial position of the measurement point, between the running surface and the bottom of the cut-out.

The cut-outs may be of two types, namely grooves and sipes. Grooves are wide cut-outs, essentially used for storing and removing water or mud present on the ground. A cut-out is said to be wide when its thickness is such that the facing walls of material that delimit it do not come into contact with one another when the tread moves through the contact area, where the tire conforms to recommended inflation and loading conditions such as those defined notably, for example, in the ISO 4250 standard and the Tire and Rim Association (TRA) standard. Sipes are narrow cut-outs, whose intersections with the running surface, or edges, contribute to grip on wet ground, because of an edge effect in contact with the ground which can break the film of water present on the ground. A cut-out is said to be narrow if its width is such that the facing walls of material delimiting it come into contact with one another at least partially when the tread moves through the contact area, in the tire loading and pressure conditions specified by the TRA standard as mentioned above.

A cut-out is commonly characterized by a mean surface, equidistant from the walls, delimiting the cut-out and cutting the running surface. The intersection of this mid-surface and the running surface is called the mean line of the cut-out. The mean line of a cut-out is not necessarily straight, but may, for example, have an undulating or zigzag shape. A cut-out is said to be longitudinal when its mean line has a longitudinal mean direction; that is to say, when it lies at a mean angle of not more than 45° to the longitudinal direction. A longitudinal cut-out usually extends all round the tire. A cut-out is said to be transverse when its mean line has a transverse mean direction; that is to say, when it lies at a mean angle of not more than 45° to the transverse direction. A transverse cut-out joins two longitudinal cut-outs to one another, or joins a longitudinal cut-out to an edge of the tread.

In the case of a tire tread for a heavy civil engineering vehicle, the relief elements are usually blocks. A block is a volume of material delimited by a contact face, contained in the running surface by a bottom surface and by side faces linking the contact face to the bottom surface. These blocks may be arranged so as to form longitudinal rows of blocks, these rows being separated in pairs by longitudinal cut-outs in the form of grooves or sipes, also called longitudinal channels. Within a single longitudinal row of blocks, the blocks are usually separated in pairs by transverse cut-outs in the form of grooves or sipes.

The tread, integrated into the tire, is usually characterized geometrically by a width L in the transverse direction and a height H in a direction perpendicular to the running surface. The width L is defined as the transverse width of the contact area of the tire tread when new, on smooth ground such as a tarmac surface, when the tire conforms to nominal pressure and loading conditions such as those recommended by the TRA standard. The height H is defined, by convention, as the maximum radial depth measured in the cut-outs, corresponding to the maximum radial block height, in the new state. In the case of a tire for a civil engineering vehicle of the dumper type, by way of example, the width L is at least 600 mm and the height H is at least 60 mm, or possibly 70 mm.

The usual running conditions for a tire of a civil engineering vehicle are particularly severe. Such a vehicle is generally designed to run on rough stony tracks, requiring good resistance to attack in the treads of the tires fitted to the vehicle, to ensure that these tires have a satisfactory service life. Furthermore, the loads on the tire, which are usually high, result in considerable heat dissipation, particularly in the crown of the tire, creating temperature rises that may degrade the rubber-based materials of the tire crown and lead to premature destruction of the tire. Resistance of the tread to attack, and thermal control of the crown, are therefore two major requirements for a tire to be fitted to a heavy civil engineering vehicle.

Regarding the thermal control of the crown, it is known that the tire crown temperature decreases as the degree of aeration of the tread increases, in other words as the volume of cut-outs providing ventilation increases. However, the current tendency is to develop treads with a longer life, which therefore have an increased volume of wearable material, that is to say a reduced volume of cut-outs. Thus, document WO 2017162953A1 proposes what is called a siped tread, in which the sipes may, however, be sensitive to attack and insufficiently effective in terms of thermal ventilation. Document WO 2020229176A1 proposes a siped tread in which the sipes are strengthened against attack by their improved geometry, but without any improvement in the effectiveness of the ventilation provided by said sipes.

The inventors set themselves the aim of improving, for a tire tread for a heavy civil engineering vehicle, at least partially comprising blocks separated from one another by sipes, the trade-off between resistance to mechanical attack by stony ground and thermal venting.

This aim has been achieved by means of a tire tread for a heavy civil engineering vehicle, designed to come into contact with the ground via a running surface, comprising blocks delimited by cut-outs, and having a width, and a thickness defined as the maximum cut-out depth,
the tread having a median portion, symmetrical about a median longitudinal plane and having a width of not more than 60% of the width of the tread,
the median portion comprising at least one longitudinal row of blocks, wherein each block is delimited transversely by two longitudinal channels and longitudinally by two inter-block transverse cut-outs,
each longitudinal channel and each inter-block transverse cut-out, respectively, having a depth equal to at least 50% of the tread thickness, and being a staged cut-out comprising a radially outer portion opening on to the running surface and a radially inner portion extending from the radially outer portion to a radially inner end (4121, 4221),
each radially outer portion having a thickness, measured between the walls of material delimiting it, within the range from a minimum to a maximum thickness,
each radially inner portion having a thickness, measured between the walls of material delimiting it, within the range from a minimum to a maximum thickness,
the maximum thickness of each radially outer portion being equal to not more than 20% of the depth of the corresponding cut-out and strictly less than the maximum thickness of the corresponding radially inner portion,
and the minimum thickness of each radially outer portion being equal to at least 5% of the depth of the corresponding cut-out.

The invention is based essentially on an optimization of the respective thicknesses of the radially outer portion and the radially inner portion of every longitudinal or transverse cut-out delimiting every block belonging to a specific longitudinal row of blocks. Said specific longitudinal row of blocks is positioned in a median portion of the tread. The invention is intended to provide a trade-off between the crack resistance and the thermal venting of said cut-outs.

In the context of the invention, a median portion of the tread is a tread portion that is symmetrical about a median longitudinal plane passing through the middle of the tread and perpendicular to the running surface, and having a width of not more than 60% of the tread width, said tread width being measured in a transverse direction between two side edges of the running surface. The median portion contains one or more longitudinal rows of blocks according to the invention, but may also contain other sculpture elements. In other words, the median portion does not necessarily contain only longitudinal rows of blocks according to the invention.

By definition, a longitudinal cut-out delimiting a block in the median portion of the tread is called a longitudinal groove, and a transverse cut-out delimiting a block in the median portion of the tread is called an inter-block transverse cut-out.

Each longitudinal channel and each inter-block transverse cut-out, respectively, is a stated cut-out, comprising a radially outer portion opening on to the running surface and a radially inner portion extending from the radially outer portion to the bottom of the cut-out. Each radially outer portion has a thickness, measured between the walls of material delimiting it, that may vary, in the direction perpendicular to the running surface, between the running surface, that is to say the radially outermost point of said portion, and the radially innermost point of said portion: this radially outer portion thickness is therefore within the range from a minimum thickness to a maximum thickness. Similarly, each radially inner portion has a thickness, measured between the walls of material delimiting it, that may vary, in the direction perpendicular to the running surface, between the radially outermost point of said portion and the bottom of the cut-out, that is to say the radially innermost point of said portion: this radially inner portion thickness is therefore within the range from a minimum thickness to a maximum thickness. The thicknesses described above are usually measured in tread cross sections, delimited by two transverse planes which are perpendicular to the running surface.

Each longitudinal channel, and each inter-block transverse cut-out, has a measured depth, in a direction perpendicular to the running surface, between the running surface and the bottom of said longitudinal channel, or of said inter-block transverse cut-out, respectively. In the context of the invention, this depth is at least 50% of the maximum cut-out depth, which by convention is called the height of the tread, corresponding to the maximum thickness of material to be worn before all the sculpture on the running surface disappears.

According to a first essential characteristic of the invention, the maximum thickness of each radially outer portion is equal to not more than 20% of the depth of the corresponding cut-out and is strictly less than the maximum thickness of the corresponding radially inner portion.

An upper limit of the maximum thickness of the radially outer portion of a cut-out, set at 20% of the depth of the cut-out, makes it possible, on the one hand, to limit the volume of the cut-out and consequently its effect on the reduction of volume of wearable material, thereby improving its wear life, and, on the other hand, to stiffen the blocks delimited by the cut-out, by bringing into contact the walls delimiting said radially outer portion and consequently limiting the deformation at the bottom of the cut-out, and therefore the risk of cracking at the bottom of the cut-out. A radially outer portion with such a limited thickness is termed a sipe.

An upper limit on the maximum thickness of the radially outer portion of a cut-out which is strictly smaller than the maximum thickness of the corresponding radially inner portion also ensures an excess thickness of the radially inner portion of the cut-out, and therefore a limitation of the stresses at the bottom of the cut-out, thereby helping to minimize the risk of cracking at the bottom of the cut-out. Furthermore, this excess thickness of the radially inner portion also has the effect of creating an air circulation channel at the bottom of the sculpture, where heat removal is most difficult, thereby contributing to the venting of the cut-out, and consequently to the limitation of the temperature level of the tread. According to a particular embodiment of the radially inner portion, its thickness increases from a minimum value at the interface with the radially outer portion to a maximum value in the vicinity of the bottom of the cut-out. In this case, the shape of such a radially inner portion is termed a teardrop shape.

According to a second essential characteristic of the invention, the minimum thickness of each radially outer portion is equal to at least 5% of the depth of the corresponding cut-out.

A lower limit of the minimum thickness of each radially outer portion set at 5% of the depth of the corresponding cut-out ensures air circulation in the radially outer portion, contributing to the venting of the cut-out, and consequently limiting the temperature level of the tread.

Preferably, the minimum thickness of each radially outer portion is equal to at least 10% of the depth of the corresponding cut-out. A lower limit of the minimum thickness of each radially outer portion set at 10% of the depth of the corresponding cut-out further improves air circulation in the radially outer portion, contributing to better venting of the cut-out, and consequently providing further and even more effective limitation of the temperature level of the tread, while still maintaining sufficient locking in the contact area.

Preferably, also, the minimum and maximum thickness of each radially outer portion are equal to one another, so that the thickness is constant at every point of said radially outer portion. In this case, the thickness of the radially outer portion is constant over the whole height of said radially outer portion, allowing an air circulation channel of constant cross section to be provided, thereby ensuring uniform and effective venting over the whole height of the radially outer portion.

Advantageously, the maximum thickness of each radially inner portion is at least equal to 15% of the depth of the corresponding cut-out. A lower limit of the maximum thickness of each radially inner portion set at 15% of the depth of the corresponding cut-out makes it possible to prevent the cracking of the bottom of the cut-out during the time taken for the wear level of the tread to reach the bottom of the cut-out. In other words, this lower limit ensures that the wear level reaches the depth of the cut-out without the appearance of cracking.

Also advantageously, each radially inner portion has a height at least equal to 1.5 times the maximum thickness of the corresponding radially inner portion. If the radially inner portion has a teardrop shape, with its thickness varying from a minimum thickness at the level of the transition to the radially outer portion to a maximum thickness at the bottom of the cut-out, the angle of each wall of said radially inner portion to the radial direction, usually called the clearance angle, makes it possible, on the one hand, to limit the demoulding force on the strip used for moulding the cut-out, and, on the other hand, to limit the degradation due to tearing of the transition region between the radially outer and radially inner portions.

Advantageously, each radially inner portion has a circular radially inner end whose diameter is equal to the corresponding maximum thickness of the radially inner portion. An arc of a circle at the radially inner end of a radially inner portion, that is to say at the bottom of a cut-out, is the shape that provides the largest constant radius of curvature, allowing the reduction of stress concentration for a given volume of the radially inner portion to be optimized, thereby reducing the risk of cracking.

Also advantageously, each block having a longitudinal length, the depth of each inter-block transverse cut-out is equal to or less than the longitudinal block length, or preferably equal to or less than 0.8 times the longitudinal block length. The ratio between the depth of each inter-block transverse cut-out and the longitudinal block length is usually called the longitudinal overhang of the block, and characterizes its longitudinal stiffness in geometrical terms. A longitudinal overhang limited to 1, preferably to 0.8, makes it possible, in particular, to limit the flexing of the block when subject to torque, and consequently the irregular wear known as sawtooth wear. A longitudinal overhang of up to 0.8 or even 1 is made possible despite the risk of temperature increase, due to the good venting capacity of the cut-outs delimiting the block.

According to a first particular embodiment, the tread comprises outer transverse cut-outs opening into the longitudinal channels delimiting the blocks, each having a depth at least equal to 50% of the height of the tread, and comprising a radially outer and a radially inner portion, each radially outer portion having a thickness in the range from a minimum to a maximum thickness, and each radially inner portion having a thickness in the range from a minimum to a maximum thickness. In this particular embodiment, the maximum thickness of each radially outer portion is equal to or less than 20% of the depth of the corresponding cut-out and strictly less than the maximum thickness of the corresponding radially inner portion. Additionally, the minimum thickness of each radially outer portion is at least equal to 5% of the depth of the corresponding cut-out. In other words, these outer transverse cut-outs have the same characteristics as those of the longitudinal channels and the inter-block transverse cut-outs, and therefore the same technical advantages of cracking resistance and thermal venting capacity.

Preferably, the minimum thickness of the radially outer portion of each outer transverse cut-out is at least equal to 10% of the depth of the corresponding cut-out. A lower limit of the minimum thickness of each radially outer portion set at 10% of the depth of the corresponding cut-out further improves air circulation in the radially outer portion, contributing to better venting of the cut-out, and consequently providing further and even more effective limitation of the temperature level of the tread, while still maintaining sufficient locking in the contact area.

Preferably, also, the minimum and maximum thicknesses of the radially outer portion of each outer transverse cut-out are equal to one another. In this case, the thickness of the radially outer portion is constant over the whole height of said radially outer portion, allowing an air circulation channel of constant cross section to be provided, thereby ensuring uniform and effective venting over the whole height of the radially outer portion.

Advantageously, the maximum thickness of the radially inner portion of each outer transverse cut-out is at least equal to 15% of the depth of the corresponding cut-out. A lower limit of the maximum thickness of each radially inner portion set at 15% of the depth of the corresponding cut-out makes it possible to prevent the cracking of the bottom of the cut-out during the time taken for the wear level of the tread to reach the bottom of the cut-out. In other words, this lower limit ensures that the wear level reaches the depth of the cut-out without the appearance of cracking.

Also advantageously, the radially inner portion of each outer transverse cut-out has a height at least equal to 1.5 times the maximum thickness of the corresponding radially inner portion. If the radially inner portion has a teardrop shape, with its thickness varying from a minimum thickness at the level of the transition to the radially outer portion to a maximum thickness at the bottom of the cut-out, the angle of each wall of said radially inner portion to the radial direction, usually called the clearance angle, makes it possible, on the one hand, to limit the demoulding force on the strip used for moulding the cut-out, and, on the other hand, to limit the degradation due to tearing of the transition region between the radially outer and radially inner portions.

Advantageously, the radially inner portion of each outer transverse cut-out has a circular radially inner end whose diameter is equal to the maximum thickness of the corresponding radially inner portion. An arc of a circle at the radially inner end of a radially inner portion, that is to say at the bottom of a cut-out, is the shape that provides the largest constant radius of curvature, allowing the reduction of stress concentration for a given volume of the radially inner portion to be optimized, thereby reducing the risk of cracking.

According to a second particular embodiment, each block comprises at least one internal cut-out having a depth not greater than the smallest of the respective depths of each longitudinal channel and of each inter-block transverse cut-out delimiting the block. The presence of at least one cut-out within the blocks creates supplementary cooling of the tread, which may possibly allow the use of a tread rubber composition that is more hysteretic, in other words one that generates more heat but is more resistant to attack. Preferably, but not necessarily, an internal cut-out opens into the faces of the block. If it does not open into the faces of the block, it is called “blind”.

Advantageously, each internal cut-out comprising a radially outer portion having a thickness in the range from a minimum to a maximum thickness, the maximum thickness of the radially outer portion of the internal cut-out is equal to or less than the smallest of the maximum thicknesses of the radially outer portion of each longitudinal channel and of each inter-block transverse cut-out delimiting the block. An internal cut-out having a smaller depth and a smaller maximum thickness of the radially outer portion than those of a longitudinal channel and those of an inter-block transverse cut-out has the same venting capacity as a longitudinal channel and an inter-block transverse cut-out. An interior cut-out volume that is limited in this way makes it possible to avoid an excessive reduction in the volume of wearable material, and consequently in the wear life.

Advantageously, also, the maximum thickness of the radially outer portion of the internal cut-out is at least equal to 5% and at most equal to 20% of the depth of the corresponding internal cut-out. This range of values for the maximum thickness provides a satisfactory compromise between the venting capacity of the internal cut-out and its effect on the reduction of the volume of wearable material.

Advantageously, the minimum thickness of the radially outer portion of the internal cut-out is at least equal to 5%, or preferably at least equal to 10%, of the depth of the corresponding internal cut-out. This upper limit of the minimum thickness contributes to optimal venting of the internal cut-out.

Preferably, the minimum and maximum thicknesses of the radially outer portion of each internal cut-out are equal to one another, so that the thickness is constant at every point of said radially outer portion. In this case, the thickness of the radially outer portion is constant over the whole height of said radially outer portion, allowing an air circulation channel of constant cross section to be provided, thereby ensuring uniform and effective venting over the whole height of the radially outer portion.

Preferably, also, each internal cut-out comprising a radially inner portion having a thickness in the range from a minimum to a maximum thickness, the maximum thickness of the radially outer portion of the internal cut-out is strictly less than the maximum thickness of the radially inner portion of the corresponding internal cut-out. If the rubber composition of the tread has a slow wear rate, the time taken for the wear to reach the bottom of an internal cut-out may be long enough for cracking to be initiated in the bottom of this internal cut-out. In this case, it is helpful for the cut-out to have a radially inner portion with an enlarged thickness, resembling a teardrop in shape, to reduce the risk of cracking.

Advantageously, the maximum thickness of the radially inner portion of the internal cut-out is at least equal to 15% of the depth of the corresponding internal cut-out. A lower limit of the maximum thickness of each radially inner portion set at 15% of the depth of the corresponding internal cut-out makes it possible to prevent the cracking of the bottom of the internal cut-out during the time taken for the wear level of the tread to reach the bottom of the internal cut-out. In other words, this lower limit ensures that the wear level reaches the depth of the cut-out without the appearance of cracking.

Also advantageously, the radially inner portion of each internal cut-out has a height of at least equal to 1.5 times the maximum thickness of the radially inner portion of the corresponding internal cut-out. If the radially inner portion has a teardrop shape, with its thickness varying from a minimum thickness at the level of the transition to the radially outer portion to a maximum thickness at the bottom of the cut-out, the angle of each wall of said radially inner portion to the radial direction, usually called the clearance angle, makes it possible, on the one hand, to limit the demoulding force on the strip used for moulding the cut-out, and, on the other hand, to limit the degradation due to tearing of the transition region between the radially outer and radially inner portions.

Advantageously, the radially inner portion of each internal cut-out has a circular radially inner end whose diameter is equal to the maximum thickness of the radially inner portion of the corresponding internal cut-out. An arc of a circle at the radially inner end of a radially inner portion, that is to say at the bottom of a cut-out, is the shape that provides the largest constant radius of curvature, allowing the reduction of stress concentration for a given volume of the radially inner portion to be optimized, thereby reducing the risk of cracking.

According to a preferred variant of the second particular embodiment, each internal cut-out is transverse. A transverse direction of the internal cut-out is advantageous for the grip of the tire during braking, and consequently for safety. On the other hand, the presence of a longitudinal internal cut-out close to the median longitudinal plane of the tread weakens the tread in this area that is subject to high ground contact pressure.

According to a preferred embodiment, the median portion of the tread comprises a longitudinal row of blocks centred on the median longitudinal plane. For a tire fitted on a heavy civil engineering vehicle and operating in its usual conditions of loading and pressure, the ground contact pressure is maximal in the centre of the tread, defined by the median longitudinal plane. The presence of blocks instead of a longitudinal channel in this area enables the tread to be more robust.

For protection against attack by stones, it may be advantageous to have an excess thickness at the bottom of the cut-out, especially at the intersections between the various cut-outs described above, namely longitudinal channels, inter-block transverse cut-outs and outer transverse cut-outs.

The presence of stone guard protuberances, in the form of ribs, may be advantageous, particularly in longitudinal channels.

The invention also relates to a tire to be fitted to a heavy civil engineering vehicle, comprising a tread according to any of the embodiments described above.

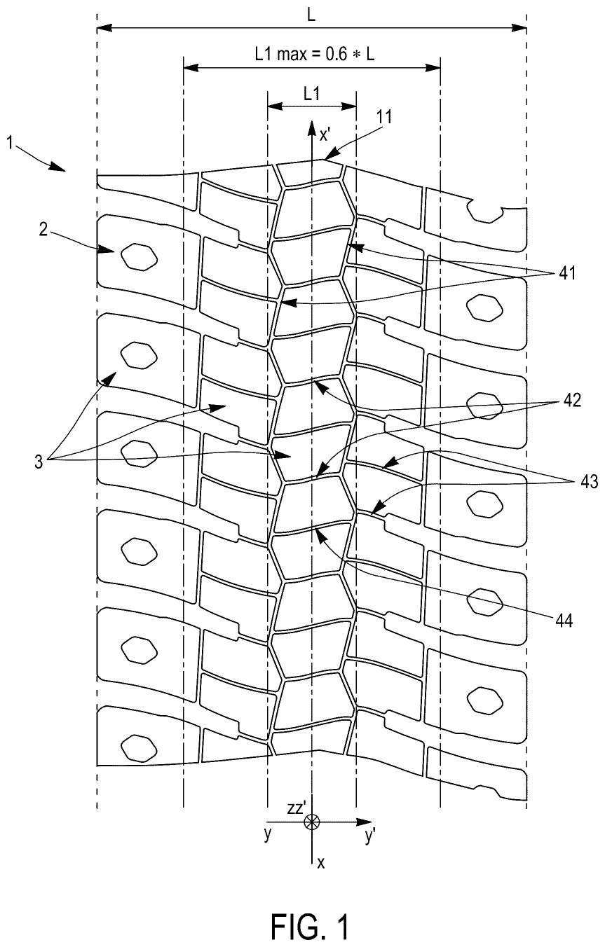

The characteristics of the invention are illustrated in FIGS. 1 to 8 below, which are schematic and not to scale:

FIG. 1: Top view of a tread according to the invention

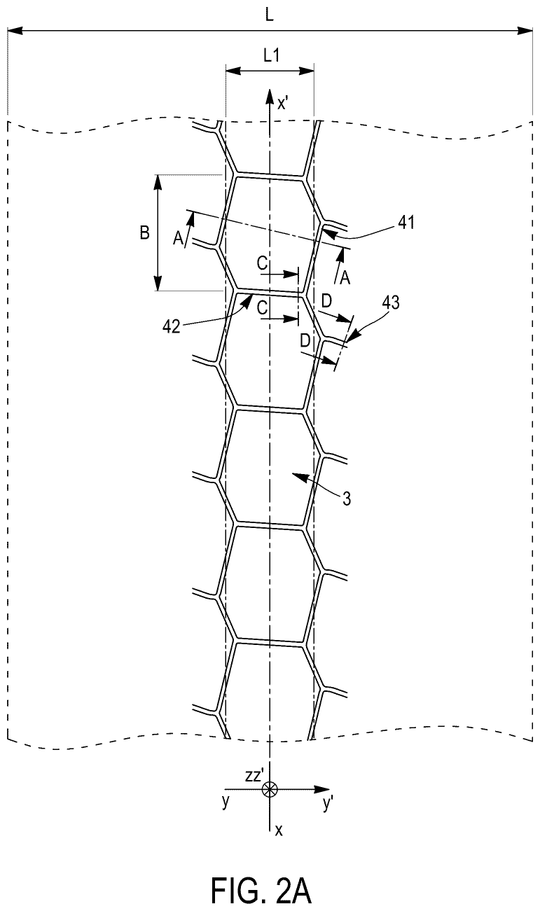

FIG. 2A: Top view of a median portion of a tread according to the invention

FIG. 2B: Sectional view of a longitudinal channel of a median portion of a tread according to the invention

FIG. 2C: Sectional view of an inter-block transverse cut-out of a median portion of a tread according to the invention

FIG. 2D: Sectional view of an outer transverse cut-out of a median portion of a tread according to the invention

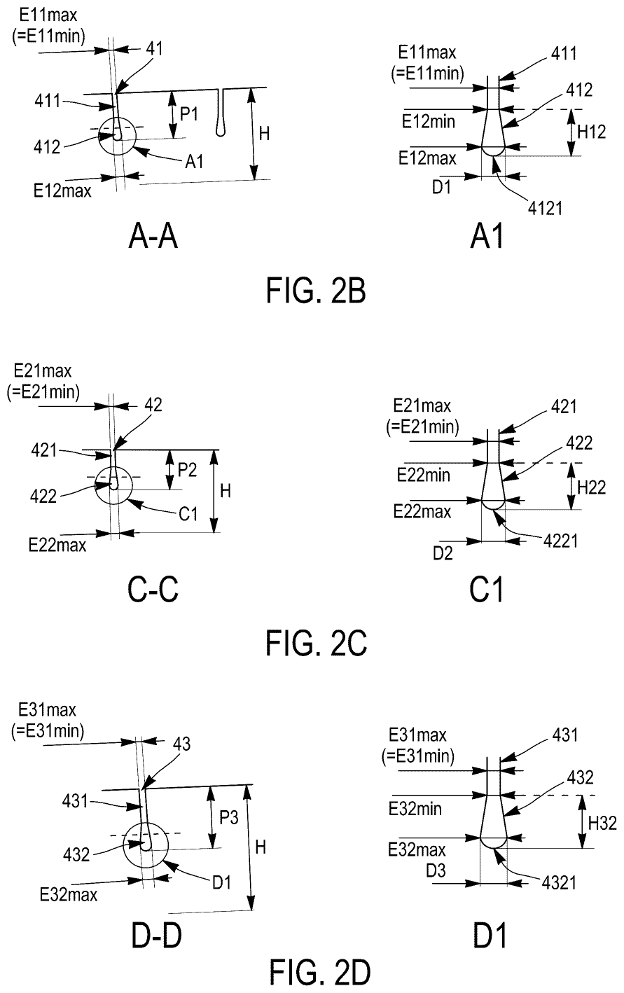

FIG. 3A: Top view of a median portion of a tread according to a particular embodiment of the invention, comprising inner transverse cut-outs

FIG. 3B: Sectional view of a median portion of a tread according to a particular embodiment of the invention, comprising inner transverse cut-outs

FIG. 3C: Sectional view of an inner transverse cut-out comprising a single portion

FIG. 3D: Sectional view of an inner transverse cut-out comprising a radially outer portion and a radially inner portion

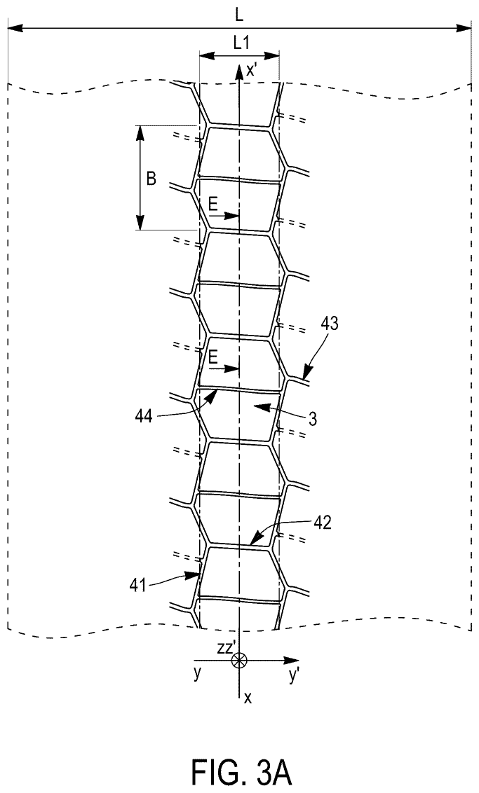

FIG. 4: First range of variation of a thickness of a radially outer portion of a longitudinal channel, of an inter-block transverse cut-out and of an outer transverse cut-out respectively, as a function of the depth of cut-out

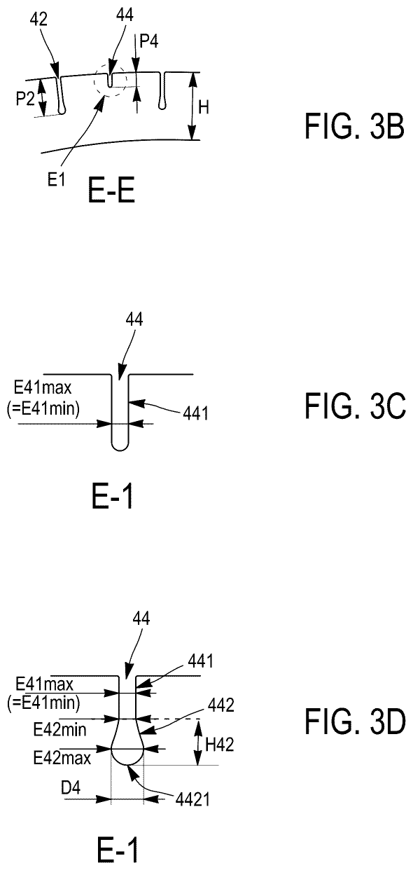

FIG. 5: First range of variation of a thickness of a radially outer portion of a longitudinal channel, of an inter-block transverse cut-out and of an outer transverse cut-out respectively, as a function of the depth of the cut-out

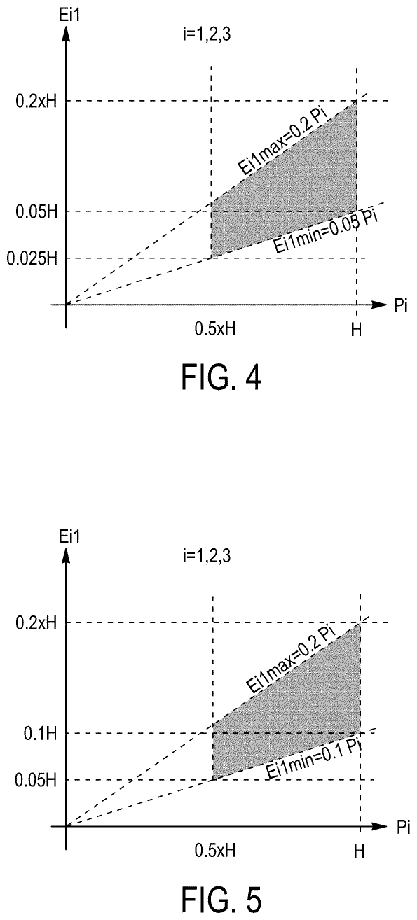

FIG. 6: First range of variation of a thickness of a radially outer portion of an internal cut-out, as a function of the depth of the internal cut-out

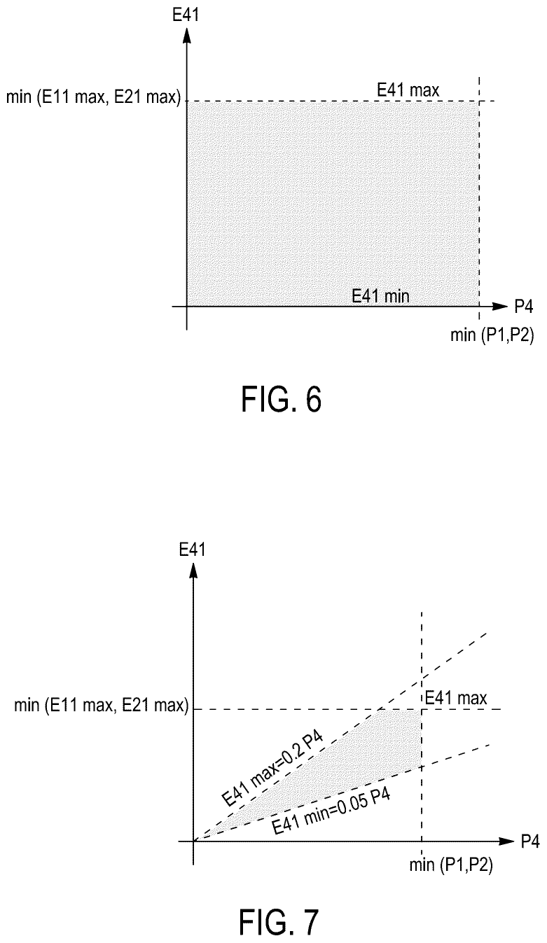

FIG. 7: Second range of variation of a thickness of a radially outer portion of an internal cut-out, as a function of the depth of the internal cut-out

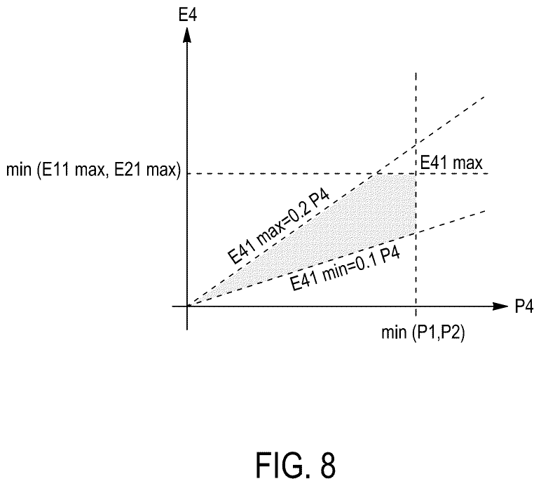

FIG. 8: Third range of variation of a thickness of a radially outer portion of an internal cut-out, as a function of the depth of the internal cut-out

FIG. 1 is a top view of a tread 1 according to the invention. The tire tread 1 for a heavy civil engineering vehicle, designed to contact the ground via a running surface 2, comprises blocks 3 delimited by cut-outs (41, 42), and has a width L in a transverse direction YY′ and a height H (not shown in FIG. 1) in a direction ZZ′, defined as the maximum cut-out depth perpendicular to the running surface 2. The tread has a median portion 11 which is symmetrical about a median longitudinal plane XZ and has a width L1 equal to not more than L1max=60% of the width L of the tread. In the embodiment shown in FIG. 1, the median portion 11 is formed by a single longitudinal row of blocks 3, each block 3 of which is delimited transversely, in the transverse direction YY′, by two longitudinal channels 41, and longitudinally, in a longitudinal direction XX′, by two inter-block transverse cut-outs 42. This single longitudinal row of blocks 3 of width L1 is centred on the median longitudinal plane XZ. More generally, the median portion 11 may comprise a plurality of longitudinal rows of blocks according to the invention, or a combination, in the transverse direction, of at least one longitudinal row of blocks according to the invention with other sculpture elements. In the embodiment shown in FIG. 1, the tread 1 also comprises outer transverse cut-outs 43, opening into the longitudinal channels 41 delimiting the blocks 3.

FIG. 2A is a top view of a median portion of a tread according to the invention. As may be seen in FIG. 1, the median portion of the tread has a width L1 equal to not more than 60% of the tread width L. Every block 3 of the median portion has a longitudinal length B, which may vary from one block to another. The section plane A-A defines a cross section through a longitudinal channel 41, as shown in FIG. 2B. The section plane C-C defines a cross section through an inter-block transverse cut-out 42, as shown in FIG. 2C. The section plane D-D defines a cross section through an outer transverse cut-out 43, as defined in FIG. 2D.

FIG. 2B is a sectional view of a longitudinal channel 41 of a median portion of a tread according to the invention. FIG. 2B shows, on the one hand, the section A-A through the longitudinal channel 41 as a whole, and, on the other hand, a detail view A1 of the radially inner portion 412 of said longitudinal channel 41. The longitudinal channel 41 has a depth P1 at least equal to 50% of the height H of the tread, and comprises, respectively, a radially outer portion 411 and a radially inner portion 412. In the general case, the radially outer portion 411 has a thickness, measured between the walls of material delimiting it, within the range from a minimum thickness E11min to a maximum thickness E11max. In the case shown here, the minimum thickness E11min and the maximum thickness E11max of the radially outer portion 411 are equal to one another, so that the thickness is constant at every point of said radially outer portion 411. The radially inner portion 412 has a thickness, measured between the walls of material delimiting it, within the range from a minimum thickness E12min to a maximum thickness E12max, which are not equal in the general case. According to the invention, the maximum thickness E11max of the radially outer portion 411 is equal to not more than 20% of the corresponding depth P1 of the cut-out 41 and strictly less than the corresponding maximum thickness E12max of the radially inner portion 412, and the minimum thickness E11min of each radially outer portion 411 is equal to not more than 5% of the corresponding depth P1 of the cut-out 41. In the detail view A1, according to a particular embodiment, the radially inner portion 412 has a height H12 at least equal to 1.5 times its maximum thickness E12max, and a circular radially inner end 4121 whose diameter D1 is equal to its maximum thickness E12max.

FIG. 2C is a sectional view of a transverse inter-block cut-out 42 of a median portion of a tread according to the invention. FIG. 2C shows, on the one hand, the section C-C through the inter-block transverse cut-out 42 as a whole, and, on the other hand, a detail view C1 of the radially inner portion 422 of said inter-block transverse cut-out 42. The inter-block transverse cut-out 42 has a depth P2 at least equal to 50% of the height H of the tread, and comprises, respectively, a radially outer portion 421 and a radially inner portion 422. In the general case, the radially outer portion 421 has a thickness within the range from a minimum thickness E21min to a maximum thickness E21max. In the case shown here, the minimum thickness E21min and the maximum thickness E21max of the radially outer portion 421 are equal to one another, so that the thickness is constant at every point of said radially outer portion 421. The radially inner portion 422 has a thickness within the range from a minimum thickness E22min to a maximum thickness E22max, which are not equal in the general case. According to the invention, the maximum thickness E21max of the radially outer portion 421 is equal to not more than 20% of the corresponding depth P2 of the cut-out 42 and strictly less than the maximum thickness E22max of the corresponding radially inner portion 422, and the minimum thickness E21min of each radially outer portion 421 is equal to at least 5% of the depth P2 of the corresponding cut-out 42. In the detail view C1, according to a particular embodiment, the radially inner portion 422 has a height H22 equal to at least 1.5 times its maximum thickness E22max, and a circular radially inner end 4221 whose diameter D2 is equal to its maximum thickness E22max.

FIG. 2D is a sectional view of an outer transverse cut-out 43 of a median portion of a tread according to a particular embodiment of the invention. FIG. 2D shows, on the one hand, the section D-D through the outer transverse cut-out 43 as a whole, and, on the other hand, a detail view D1 of the radially inner portion 432 of said outer transverse cut-out 43. The outer transverse cut-out 43 has a depth P3 equal to at least 50% of the height H of the tread, and comprises, respectively, a radially outer portion 431 and a radially inner portion 432. In the general case, the radially outer portion 431 has a thickness within the range from a minimum thickness E31min to a maximum thickness E31max. In the case shown here, the minimum thickness E31min and the maximum thickness E31max of the radially outer portion 431 are equal to one another, so that the thickness is constant at every point of said radially outer portion 431. The radially inner portion 432 has a thickness within the range from a minimum thickness E32min to a maximum thickness E32max, which are not equal in the general case. According to a particular embodiment of the invention, the maximum thickness E31max of the radially outer portion 431 is equal to not more than 20% of the depth P3 of the corresponding cut-out 43 and strictly less than the maximum thickness E32max of the corresponding radially inner portion 432, and the minimum thickness E31min of each radially outer portion 431 is equal to at least 5% of the depth P3 of the corresponding cut-out 43. In the detail view D1, according to a particular embodiment, the radially inner portion 432 has a height H32 equal to at least 1.5 times its maximum thickness E32max, and a circular radially inner end 4321 whose diameter D3 is equal to its maximum thickness E32max.

FIG. 3A is a top view of a median portion of a tread according to a particular embodiment of the invention, comprising internal transverse cut-outs 44. In this particular embodiment, every block 3 comprises an internal transverse cut-out 44, substantially parallel to the inter-block transverse cut-outs 42 that delimit it, and opening into the 2 longitudinal channels 41 that delimit it. The section plane E-E, according to the median longitudinal plane XZ, defines a cross section through the alternating internal transverse cut-outs 44 and inter-block transverse cut-outs 42, as shown in FIG. 2B. Additionally, two types of internal cut-outs 44 are shown in the detail view E1 of FIGS. 3C and 3D respectively.

FIG. 3B is a sectional view of a median portion of a tread according to a particular embodiment of the invention, comprising internal transverse cut-outs 44. Along the longitudinal direction X, an internal transverse cut-out 44, having a depth P4, alternates with an inter-block transverse cut-out 42, having a depth P2.

FIG. 3C is a sectional view of an internal transverse cut-out 44 comprising a single portion, corresponding to the detail E1 of FIG. 3B. In this particular case, the respective radially inner and radially outer portions are combined into a single portion 441. Additionally, in the embodiment shown here, the minimum thickness E41min and the maximum thickness E41max of the portion 441 are equal to one another, so that the thickness is constant at every point of said portion 441.

FIG. 3D is a sectional view of an internal transverse cut-out 44 comprising, respectively, a radially outer portion 441 and a radially inner portion 442, corresponding to the detail E1 of FIG. 3B. In the general case, the radially outer portion 441 has a thickness within the range from a minimum thickness E41min to a maximum thickness E41max. In the case shown here, the minimum thickness E41min and the maximum thickness E41max of the radially outer portion 441 are equal to one another, so that the thickness is constant at every point of said radially outer portion 441. The radially inner portion 442 has a thickness within the range from a minimum thickness E42min to a maximum thickness E42max, which are not equal in the general case. In the detail view E1, according to a particular embodiment, the radially inner portion 432 has a height H42 equal to at least 1.5 times its maximum thickness E42max, and a circular radially inner end 4421 whose diameter D4 is equal to its maximum thickness E42max.

FIG. 4 is a first range of variation of a thickness Ei1 of a radially outer portion 4i1 of a cut-out 4i, as a function of the depth Pi of said cut-out 4i, where the index i may take the values of 1, 2 or 3. An index i equal to 1 characterizes a longitudinal channel 41, an index i equal to 2 characterizes an inter-block transverse cut-out 42, and an index i equal to 3 characterizes an outer transverse cut-out 43. The thickness Ei1 is the thickness measured at any point of the radially outer portion 4i1. For a depth Pi of between 50% of H and H, the thickness Ei1 of said radially outer portion, at any point of the cut-out 4i, is between 5% of Pi and 20% of Pi.

FIG. 5 is a second range of variation of a thickness Ei1 of a radially outer portion 4i1 of a cut-out 4i, as a function of the depth Pi of said cut-out 4i, where the index i may take the values of 1, 2 or 3. The thickness Ei1 is the thickness measured at any point of the radially outer portion 4i1. For a depth Pi of between 50% of H and H, the thickness Ei1 of said radially outer portion, at any point of the cut-out 4i, is between 10% of Pi and 20% of Pi; therefore this is a more restricted range than the first range.

FIG. 6 is a first range of variation of a thickness E41 of a radially outer portion 441 of an internal cut-out 44, as a function of its depth P4. The thickness E41 is the thickness measured at any point of the radially outer portion 441. In this first range of variation, an internal cut-out 44, formed in a block 3, has a depth P4 of not more than min (P1, P2), that is to say the smaller of the respective depths (P1, P2) of each longitudinal channel 41 and of each inter-block transverse cut-out 42 delimiting the block 3, and a thickness E41, measured at any point of the radially outer portion 441, therefore a maximum thickness E41max of not more than min (E11max, E21max), that is to say the smaller of the maximum thicknesses (E11max, E21max) of the radially outer portion (411, 421) of each longitudinal channel 41 and of each inter-block transverse cut-out 42 delimiting the block 3.

FIG. 7 is a second range of variation of a thickness E41 of a radially outer portion 441 of an internal cut-out 44, as a function of its depth P4. The thickness E41 is the thickness measured at any point of the radially outer portion 441. In this second range of variation, an internal cut-out 44, formed in a block 3, has a depth P4 of not more than min (P1, P2), that is to say the smaller of the respective depths (P1, P2) of each longitudinal channel 41 and of each inter-block transverse cut-out 42 delimiting the block 3, and a thickness E41, measured at any point of the radially outer portion 441, of between 5% of P4 and 20% of P4. This range of variation is more restricted than the first range described above.

FIG. 8 is a third range of variation of a thickness E41 of a radially outer portion 441 of an internal cut-out 44, as a function of its depth P4. The thickness E41 is the thickness measured at any point of the radially outer portion 441. In this third range of variation, an internal cut-out 44, formed in a block 3, has a depth P4 of not more than min (P1, P2), that is to say the smaller of the respective depths (P1, P2) of each longitudinal channel 41 and of each inter-block transverse cut-out 42 delimiting the block 3, and a thickness E41, measured at any point of the radially outer portion 441, of between 10% of P4 and 20% of P4. This range of variation is more restricted than the second range described above.

A tread according to the invention, as described in the preceding figures, has been tested by the inventors in the tire size of 53/80 R 63, for a tire to be fitted to a heavy civil engineering vehicle, more particularly a vehicle of the rigid dumper type. Such a tire is designed to bear a load of 82500 kg at an inflation pressure of 6 bar.

Table 1 below shows the characteristics of the tested tread:

TABLE 1

| Characteristics | Value | |
|---|---|---|
| Width L of tread | 1188 | mm |
| Height H of tread | 110 | mm |
| Width L1 of median portion of tread | 235 | mm |
| Longitudinal length B of a median portion block 3 | 260 | mm |
| Constant thickness (EE11max = E11min) of a | 10 | mm |
| radially outer portion 411 of a longitudinal channel | | |
| 41 | | |
| Minimum thickness (E12min) of a radially inner | 10 | mm |
| portion 412 of a longitudinal channel 41 | | |
| Maximum thickness (E12max) of a radially inner | 16 | mm |
| portion 412 of a longitudinal channel 41 | | |
| Height H12 of a radially inner portion 412 of a | 25 | mm |
| longitudinal channel 41 | | |
| Depth P1 of a longitudinal channel 41 | 96 | mm |
| Constant thickness (E21max = E21min) of a radially | 10 | mm |
| outer portion 421 of an inter-block transverse cut-out | | |
| 42 | | |
| Minimum thickness E22min of a radially inner | 10 | mm |
| portion 421 of an inter-block transverse cut-out 42 | | |
| Maximum thickness E22max of a radially inner | 16 | mm |
| portion 421 of an inter-block transverse cut-out 42 | | |
| Height H22 of a radially inner portion 421 of an | 33 | mm |
| inter-block transverse cut-out 42 | | |
| Depth P2 of an inter-block transverse cut-out 42 | 96 | mm |
| Constant thickness (E31max = E31min) of a radially | 10 | mm |
| outer portion 431 of an outer transverse cut-out 43 | | |
| Minimum thickness E32min of a radially inner | 10 | mm |
| portion 431 of an outer transverse cut-out 43 | | |
| Maximum thickness E32max of a radially inner | 16 | mm |
| portion 431 of an outer transverse cut-out 43 | | |
| Height H32 of a radially inner portion 431 of an | 30 | mm |
| outer transverse cut-out 43 | | |
| Depth P3 of an outer transverse cut-out 43 | 96 | mm |
| Constant thickness (E41max = E41min) of a radially | 7 | mm |
| outer portion 441 of an internal transverse cut-out 44 | | |
| Minimum thickness E42min of a radially inner | 7 | mm |
| portion 441 of an internal transverse cut-out 44 | | |
| Maximum thickness E42max of a radially inner | 7 | mm |
| portion 441 of an internal transverse cut-out 44 | | |
| Height H42 of a radially inner portion 441 of an | 0 | mm |
| internal transverse cut-out 44 | | |
| Depth P4 of an internal transverse cut-out 44 | 36 | mm |

Running tests in mines were conducted on tires according to the invention, and showed significantly improved resistance to mechanical attack by comparison with a control tire whose tread comprised simple cut-outs, particularly transverse cut-outs, without a radially inner portion. Particularly noteworthy are the absence of cracks at the bottoms of the radially inner portions of the cut-outs, and the absence of tearing of the tread blocks. In other words, a tread according to the invention reaches the fully worn state without cracking, whereas a control tread is subject to cracking and/or block tearing in the course of wear.

Regarding the improvement of the thermal venting capacity of the staged cut-outs, digital simulations have demonstrated a reduction of 8° C. in the internal temperature of the blocks when these comprise, in particular, an internal transverse cut-out.

1. A tire tread for a heavy civil engineering vehicle, designed to come into contact with the ground via a running surface, comprising blocks delimited by cut-outs, and having a width L and a height H, defined as the maximum cut-out depth,
the tread having a median portion, symmetrical about a median longitudinal plane (XZ) and having a width L1 of not more than 60% of the width L of the tread,
the median portion comprising at least one longitudinal row of blocks, wherein each block is delimited transversely by two longitudinal channels and longitudinally by two inter-block transverse cut-outs,
each longitudinal channel and each inter-block transverse cut-out, respectively, having a depth (P1, P2) equal to at least 50% of the tread height H, and being, respectively, a staged cut-out comprising a radially outer portion opening on to the running surface and a radially inner portion extending from the radially outer portion to a radially inner end,
each radially outer portion having a thickness, measured between the walls of material delimiting it, within the range from a minimum thickness (E11min, E21min) to a maximum thickness (E11max, E21max),
each radially inner portion having a thickness, measured between the walls of material delimiting it, within the range from a minimum thickness (E12min, E22min) to a maximum thickness (E12max, E22max),
wherein the maximum thickness (E11max, E21max) of each radially outer portion is equal to not more than 20% of the depth (P1, P2) of the corresponding cut-out and strictly less than the maximum thickness (E12max, E22max) of the corresponding radially inner portion, and wherein the minimum thickness (E11min, E21min) of each radially outer portion is equal to at least 5% of the depth (P1, P2) of the corresponding cut-out.

2. The tread according to claim 1, wherein the minimum thickness (E11min, E21min) of each radially outer portion is equal to at least 10% of the depth (P1, P2) of the corresponding cut-out.

3. The tread according to claim 1, wherein the minimum thickness (E11min, E21min) and the maximum thickness (E11max, E21max) of each radially outer portion are equal to one another, so that the thickness at all points of said radially outer portion is constant.

4. The tread according to claim 1, wherein the maximum thickness (E12max, E22max) of each radially inner portion is equal to at least 15% of the depth (P1, P2) of the corresponding cut-out.

5. The tread according to claim 1, wherein each radially inner portion has a height (H12, H22) equal to at least 1.5 times the maximum thickness (E12max, E22max) of the corresponding radially inner portion.

6. The tread according to claim 1, wherein each radially inner portion has a circular radially inner end whose diameter (D1, D2) is equal to the maximum thickness (E12max, E22max) of the corresponding radially inner portion.

7. The tread according to claim 1, with each block having a longitudinal length B, wherein the depth P2 of each inter-block transverse cut-out is equal to not more than the longitudinal length B of the block.

8. The tread according to claim 1, further comprising outer transverse cut-outs, opening into the longitudinal channels delimiting the blocks, each having a depth P3 equal to at least 50% of the tread height H, and comprising a radially outer portion and a radially inner portion,
each radially inner portion having a thickness within the range from a minimum thickness E31min to a maximum thickness E31max, each radially inner portion having a thickness in the range from a minimum thickness E32min to a maximum thickness E32max, wherein the maximum thickness E31max of each radially outer portion is equal to not more than 20% of the depth P3 of the corresponding cut-out and strictly less than the maximum thickness E32max of the corresponding radially inner portion, and wherein the minimum thickness E31min of each radially outer portion is equal to at least 5% of the depth P3 of the corresponding cut-out.

9. The tread according to claim 1, wherein each block comprises at least one internal cut-out having a depth P4 not greater than the smallest of the respective depths (P1, P2) of each longitudinal channel and of each inter-block transverse cut-out delimiting the block.

10. The tread according to claim 9, each internal cut-out (44) comprising a radially outer portion having a thickness in the range from a minimum thickness E41min to a maximum thickness E41max, wherein the maximum thickness E41max of the radially outer portion of the internal cut-out is not greater than the smallest of the maximum thicknesses (E11max, E21max) of the radially outer portion of each longitudinal channel and of each inter-block transverse cut-out delimiting the block.

11. The tread according to claim 10, each internal cut-out comprising a radially inner portion having a thickness in the range from a minimum thickness E42min to a maximum thickness E42max, wherein the maximum thickness E41max of the radially outer portion of the internal cut-out is strictly less than the maximum thickness E42max of the radially inner portion of the corresponding internal cut-out.

12. The tread according to claim 9, wherein each internal cut-out is transverse.

13. The tread according to claim 1, wherein the median portion of the tread comprises a longitudinal row of blocks centred on the median longitudinal plane (XZ).

14. A tire to be fitted to a heavy civil engineering vehicle, comprising a tread according to claim 1.

15. The tread of claim 7, wherein the depth P2 of each inter-block transverse cut-out is not more than 0.8 times the longitudinal length B of the block.
